(19) United States
(12) Patent Application Publication
(10) Pub. No.: US 2007/0248249 A1
(43) Pub. Date: Oct. 25, 2007

(54) Fingerprint identification system for access control

(75) Inventor: Alexei Stoianov, Toronto (CA)

Correspondence Address: MICHAEL BEST & FRIEDRICH LLP, 100 E WISCONSIN AVENUE, Suite 3300, MILWAUKEE, WI, 53202, US

(73) Assignee: Bioscrypt Inc.

(21) Appl. No.: 11/408,094

(22) Filed: Apr. 20, 2006

(51) Int. Cl. G06K 9/00

(52) U.S. Cl. 382/124

(57) ABSTRACT

A one-to-many identification system for access control allows a search rate of up to ˜1:30,000 in a real time. The system uses a very fast pattern based screening algorithm followed by a fast minutiae based screening algorithm. A fused score of both algorithms is used as a decision metric to screen out a vast majority of all the templates after the second stage. The remaining templates are sent to a full minutiae based algorithm to obtain a minutiae comparison score. If the result is still inconclusive after the third stage, a full pattern based algorithm is run, and its score is fused with the minutiae comparison score. The system also uses an adaptive classification technique which minimizes a distance between each template and a number of templates. The system can be realised as a standalone unit or on a server.

### BACKGROUND OF THE INVENTION

This invention relates to one-to-many biometric identification.

In the past ten to fifteen years biometrics, and particularly fingerprints, have become increasingly attractive for access control, both physical and logical. Biometrics add a new level of security to access control systems as a person attempting access must prove who he/she really is by presenting a biometric (in most cases, a fingerprint) to the system. Such systems also have the convenience, from the user's perspective, of not requiring the user remember a password. One of the biggest challenges for any automatic biometric system is the necessary tradeoff between accuracy and speed: the system must make a decision in a real time, i.e. within a few seconds, and yet this decision must have sufficient accuracy. The accuracy of a biometric system is usually characterized by a false rejection rate (FRR) and a false acceptance rate (FAR).

There are two basic types of a biometric systems: verification systems and identification systems. Assuming the biometric is a fingerprint, in a verification system, which is also known as a 1:1 system, a person claims who he/she is by entering a user name or by presenting a token or smart card or the like, then a pre-enrolled fingerprint template is retrieved from storage or is read in from the token/smart card. The person is asked to present a fingerprint on a fingerprint sensor. After the fingerprint is captured, it is verified against the template by a fingerprint verification algorithm. If the system makes a positive verification decision, the person is granted access, either physical or logical.

In an identification system, which is also known as a one-to-many system, a person does not have to claim who he/she is: the system is designed to recognize the person by comparing the person's fingerprint with a list of pre-enrolled templates. The identification system is very attractive for access control, since a person does not have to carry any token or smart card and does not need to type anything.

In the past, fingerprint identification was used primarily for forensic purposes and for background checks, such as for assessing a welfare entitlement. Such systems operate with a huge database of templates and utilize powerful computing resources. Further, the identification does not necessarily have to be performed in real time. However, increasingly, fingerprint identification systems have been developed for access control. Reported one-to-many systems can identify a fingerprint against about 1,000 to 2,000 stored templates. In many cases this is insufficient for the access control market, which is dominated by 1:1 systems. It is believed that a one-to-many system would have broader application if it were capable of searching up to about 30,000 templates.

A key part of any fingerprint system is a matching algorithm. There are two basic types of the algorithm: minutiae based and pattern based. Minutiae based algorithms extract from a fingerprint image some specific points (called minutiae), and match only those points. On the other hand, pattern based algorithms match the entire pattern, or significant parts of it, for two images. Pattern based algorithms are, in general, more robust in real life 1:1 applications, such as in access control. For one-to-many identification, minutiae algorithms have an advantage in speed over the pattern based algorithms and, indeed, most commercially available algorithms are minutiae based. However, for an access control system containing up to 30,000 templates, the accuracy of minutiae based algorithms might be insufficient, especially where the system must be able to perform up to 30,000 comparisons in real time using relatively low computing power (e.g., a DSP).

Therefore, there remains a need for an improved biometric one-to-many identification system.

### SUMMARY OF THE INVENTION

This invention seeks to provide a biometric one-to-many identification system which, in some embodiments, may be capable of handling a search of up to about 30,000 templates in real time. In one aspect, the invention provides novel screening pattern based methods which are orthogonal to existing minutiae and/or pattern based algorithms, and are combined with them via score fusion.

According to the present invention, there is provided a method of biometric identification, comprising: for each biometric template in a first universe of templates, determining a first metric of similarity between each first universe template and a candidate biometric; based on determined first metrics of similarity, selectively accepting or rejecting said each first universe template as a possible match for said candidate biometric to thereby accept a second universe of templates, said second universe of templates being a sub-set of said first universe of templates; for each second universe template, determining a second metric of similarity between said each second universe template and said candidate biometric; determining a composite metric of similarity based on said first metric of similarity for said each second universe template and said second metric of similarity for said each second universe template.

The method may further comprise: based on determined composite metrics of similarity, selectively accepting or rejecting said each second universe template as a possible match for said candidate biometric to thereby accept a third universe of templates, said third universe of templates being a sub-set of said second universe of templates.

In the method, the first metric of similarity may be, at least in part, a measure of similarity between a translation invariant biometric feature vector representation of said each first universe template and a translation invariant biometric feature vector representation of said candidate biometric.

In the method, said first metric of similarity may be at least substantially orthogonal to said second metric of similarity.

In the method, the translation invariant biometric feature vector representation of said each first universe template may be a Fourier intensity representation and wherein said translation invariant biometric feature vector representation of said candidate biometric may be a Fourier intensity representation.

In the method, said translation invariant biometric feature vector representation of said each first universe template may be a gradient magnitude representation linked to an alignment feature and wherein said translation invariant biometric feature vector representation of said candidate biometric may be a gradient magnitude representation linked to an alignment feature.

In the method, said translation invariant biometric feature vector representation of said each first universe template may be a gradient direction representation linked to an alignment feature and wherein said translation invariant biometric feature vector representation of said candidate biometric may be a gradient direction representation linked to an alignment feature.

In the method, the first metric of similarity may also be based on a metric of similarity between a gradient magnitude representation of said each first universe template linked to an alignment feature and a gradient magnitude representation of said candidate biometric linked to an alignment feature.

In the method, said first metric of similarity may also be based on a metric of similarity between a gradient direction representation of said each first universe template linked to an alignment feature and a gradient direction representation of said candidate biometric linked to an alignment feature.

In the method, the gradient magnitude of said candidate biometric and said gradient direction of said candidate biometric may be obtained at pre-selected points relative to said alignment feature.

In the method, the candidate biometric may be a fingerprint and each said alignment feature may be a core or delta of said fingerprint.

In the method, the second universe of templates may have a pre-determined number of templates and wherein said selectively accepting or rejecting said each first universe template as a possible match for said candidate biometric to thereby accept said second universe of templates comprises accepting first universe templates until said pre-determined number of templates may be reached.

In the method, the translation invariant biometric feature vector representation of said each first universe template may comprise a set of two-dimensional locations and the translation invariant biometric feature vector of said candidate biometric may comprise a value of a Fourier Transform intensity of said candidate biometric at each location of said set of two-dimensional locations.

In the method, the first metric of similarity may comprise a sum of each said value.

In the method, the Fourier Transform intensity of said candidate biometric may be a randomized Fourier Transform intensity.

The method may further comprise obtaining said Fourier intensity representation of said candidate biometric as follows: obtaining a two-dimensional representation of a Fourier Transform intensity from said candidate biometric; for each area of a plurality of areas spanning pre-selected Fourier frequencies, obtaining a value representative of said area so as to obtain a set of values, said set of values comprising said Fourier intensity representation of said candidate biometric.

The method may further comprise obtaining said Fourier intensity representation of said candidate biometric as follows: obtaining a two-dimensional representation of a Fourier Transform intensity from a candidate biometric image; obtaining a circular harmonic expansion of said Fourier Transform intensity; obtaining a representation of magnitude of a pre-determined number of lowest order circular harmonics so as to obtain a set of values, said set of values comprising said Fourier intensity representation of said candidate biometric.

In the method, the determining said composite metric of similarity may comprise: retrieving parameters defining straight line segments and deriving said composite metric of similarity from said first metric of similarity, said second metric of similarity, and said parameters.

In the method, the straight line segments may be derived as follows: for each of a plurality of authorized biometrics, deriving a template; for each of a plurality of candidate biometrics, each candidate biometric being either one of said authorized biometrics or an unauthorized biometric:—for each said template: obtaining said first metric of similarity between said each candidate and said template; obtaining said second metric of similarity between said each candidate and said template; plotting said first metric of similarity and said second metric of similarity as a point on a Cartesian plot; bisecting said plot with said straight line segments such that said plot may be bisected into a region dominated by points representative of metrics of similarity between templates and candidate biometrics from which said templates might be derived and a region dominated by points representative of metrics of similarity between templates and candidate biometrics which are other than candidate biometrics from which said templates might be derived.

In the method, each straight line segment may be defined by ax+by+c=0 and said composite metric of similarity may be determined from parameters for at least one of said straight line segments as ax+by+c where x is said first metric of similarity and y is said second metric of similarity.

The method may further comprise: for each template in one of said first universe of templates and said second universe of templates, obtaining a template characteristic vector; for said candidate biometric, obtaining a candidate characteristic vector; determining a distance between said candidate biometric and said each template based on said template characteristic vector and said candidate characteristic vector; obtaining a list of selected templates such that each selected template may have a lower distance from said candidate biometric than any template which may not be a selected template; for each of said selected templates, comparing said list of selected templates with a list of neighbour templates associated with each selected template to obtain a further metric of similarity between said candidate biometric and said each selected template.

In the method, the further metric of similarity may comprise a degree of overlap between said list of selected templates and said list of neighbour templates.

In the method, each template may be in said first universe of templates and wherein each said first metric of similarity may be, at least in part, a measure of similarity between said candidate characteristic vector and one said template characteristic vector.

In the method, each said first metric of similarity may be further derived from said further metric of similarity.

In the method, the candidate characteristic vector may be a translation invariant biometric feature vector representation of said candidate biometric and each said template characteristic vector may be a translation invariant biometric feature vector representation of said each first universe template.

In the method, the candidate biometric may be a pixelated candidate image and wherein said determining a second metric of similarity between said each second universe template and said pixelated candidate image may comprise: determining a pre-defined fiducial point in said pixelated candidate image; extracting a plurality of rectangular arrays of pixels from said pixelated candidate image, each rectangular array having a pre-defined location with respect to said fiducial point in said pixelated candidate image; comparing values at pre-selected points of at least some of said rectangular arrays of pixels with values at corresponding pre-selected points stored in respect of rectangular arrays previously extracted from said each second universe template.

According to another aspect of the invention, there is provided a biometric identification device, comprising: a biometric sensor for obtaining a candidate biometric; a memory storing a first universe of biometric templates; a controller operable to: for each biometric template in said first universe of biometric templates, determine a first metric of similarity between each first universe template and said candidate biometric; based on determined first metrics of similarity, selectively accept or reject said each first universe template as a possible match for said candidate biometric to thereby accept a second universe of templates, said second universe of templates being a sub-set of said first universe of templates; for each second universe template, determine a second metric of similarity between said each second universe template and said candidate biometric; determine a third metric of similarity between said each second universe template and said candidate biometric, said third metric of similarity based on said first metric of similarity for said each second universe template and said second metric of similarity for said each second universe template.

According to a further aspect of the invention, there is provided a method to facilitate one-to-many biometric identification, comprising: obtaining a two-dimensional representation of a Fourier Transform intensity from an input biometric image; applying a pre-selected randomisation function to said representation of a Fourier Transform intensity to obtain a randomized Fourier Transform intensity representation; identifying two-dimensional locations in said randomized Fourier Transform intensity representation containing a pre-determined number of largest positive values and a pre-determined number of largest negative values; storing each said location as a template for said input biometric image.

According to another aspect of the invention, there is provided a method of one-to-many biometric identification, comprising: obtaining a two-dimensional representation of a Fourier Transform intensity from a candidate biometric image; retrieving a set of two-dimensional locations from a template; obtaining a value of said representation at each location of said set of two-dimensional locations; summing each said value to obtain a metric of similarity of said candidate biometric image with said template.

The method may further comprise applying a pre-selected randomisation function to said representation of a Fourier Transform intensity prior to said obtaining a value.

According to another aspect of the invention, there is provided a method to facilitate one-to-many biometric identification, comprising: obtaining a two-dimensional representation of a Fourier Transform intensity from an input biometric image; for each area of a plurality of areas spanning pre-selected Fourier frequencies, obtaining a value representative of said area; storing each said value as a template for said biometric image.

According to a further aspect of the invention, there is provided a method of one-to-many biometric identification, comprising: obtaining a two-dimensional representation of a Fourier Transform intensity from a candidate biometric image; for each area of a plurality of areas spanning pre-selected Fourier frequencies, obtaining a value representative of said area so as to obtain a set of values representing a candidate biometric vector; retrieving a set of values from a template representing a template vector; obtaining a metric of similarity between said candidate biometric and said template from said candidate biometric vector and said template vector.

In the method, the obtaining said metric of similarity may comprise obtaining a vector dot product between said candidate biometric vector and said template vector.

According to another aspect of the invention, there is provided a method to facilitate one-to-many biometric identification, comprising: obtaining a two-dimensional representation of a Fourier Transform intensity from an input biometric image; obtaining a circular harmonic expansion of said Fourier Transform intensity; obtaining a representation of magnitude of a pre-determined number of lowest order circular harmonics; storing said representation as a template for said input biometric image.

According to a further aspect of the invention, there is provided a method of one-to-many biometric identification, comprising: obtaining a two-dimensional representation of a Fourier Transform intensity from a candidate biometric image; obtaining a circular harmonic expansion of said Fourier Transform intensity; obtaining a representation of magnitude of a pre-determined number of lowest order circular harmonics to obtain a set of values representing a candidate biometric vector; retrieving a set of values from a template representing a template vector; obtaining a metric of similarity between said candidate biometric vector and said template vector.

According to another aspect of the invention, there is provided a method to facilitate one-to-many biometric identification, comprising: for each of a plurality of authorized biometrics, deriving a template; for each of a plurality of candidate biometrics, each candidate biometric being either one of said authorized biometrics or an unauthorized biometric: for each said template: obtaining a first metric of similarity between said each candidate and said template; obtaining a second metric of similarity between said each candidate and said template; plotting said first metric of similarity and said second metric of similarity as a point on a Cartesian plot; bisecting said plot with straight line segments into a region dominated by points representative of metrics of similarity between templates and candidate biometrics from which said templates were derived and a region dominated by points representative of metrics of similarity between templates and candidate biometrics which are other than candidate biometrics from which said templates were derived; storing parameters defining said straight line segments.

According to a further aspect of the invention, there is provided a method of one-to-many biometric identification, comprising: obtaining a candidate biometric; obtaining a first metric of similarity between said candidate biometric and a given template; obtaining a second metric of similarity between said candidate biometric and said given template; retrieving parameters defining straight line segments and deriving a composite metric of similarity from said first metric of similarity, said second metric of similarity, and said parameters; said straight line segments derived as follows: for each of a plurality of authorized biometrics, deriving a template; for each of a plurality of candidate biometrics, each candidate biometric being either one of said authorized biometrics or an unauthorized biometric: for each said template: obtaining a first metric of similarity between said each candidate and said template; obtaining a second metric of similarity between said each candidate and said template; plotting said first metric of similarity and said second metric of similarity as a point on a Cartesian plot; bisecting said plot with said straight line segments such that said plot is bisected into a region dominated by points representative of metrics of similarity between templates and candidate biometrics from which said templates were derived and a region dominated by points representative of metrics of similarity between templates and candidate biometrics which are other than candidate biometrics from which said templates were derived.

In the method, each straight line segment may be defined by ax+by+c=0 and said composite metric of similarity may be determined from parameters for at least one of said straight line segments as ax+by+c where x is said first metric of similarity and y is said second metric of similarity.

In the method, the composite metric of similarity may be determined as the maximum value of ax+by+c for two or more of said straight line segments.

In the method, said composite metric of similarity may be determined as the minimum value of ax+by +c for two or more of said straight line segments.

According to another aspect of the invention, there is provided a method to facilitate one-to-many biometric identification, comprising: for each biometric of a plurality of biometrics, obtaining a template comprising a characteristic vector representing said each biometric; determining a distance between each pair of templates based on each said characteristic vector; based on distance determinations between each pair of templates, for said each template determining nearest neighbour templates; augmenting said each template with a list of said nearest neighbour templates.

The method may further comprise further augmenting said each template with said list of nearest neighbour templates associated with each of said nearest neighbour templates.

According to a further aspect of the invention, there is provided a method of one-to-many biometric identification, comprising: for each template in a universe of templates obtaining a template characteristic vector; for said candidate biometric, obtaining a candidate characteristic vector; determining a distance between said candidate biometric and said each template based on said template characteristic vector and said candidate characteristic vector; obtaining a list of selected templates such that each selected template has a lower distance from said candidate biometric than any template which is not a selected template; for each of said selected templates, comparing said list of selected templates with a list of neighbour templates associated with each selected template to obtain a metric of similarity between said candidate biometric and said each selected template.

In the method, the metric of similarity may comprise a degree of overlap between said list of selected templates and said list of neighbour templates.

The method may further comprise obtaining said list of neighbour templates associated with said each selected template by: determining a distance between each pair of templates based on said template characteristic vector; for each template, selecting said list of neighbour templates such that each neighbour template may have a lower distance from said each template than any template which may not be a neighbour template.

In the method, the metric of similarity may be a classification metric and may further comprise determining a further metric of similarity between a candidate biometric and said each template based on said candidate characteristic vector and each said template characteristic vector and fusing said classification metric with said further metric to obtain a composite metric of similarity.

According to another aspect of the invention, there is provided a method to facilitate one-to-many biometric identification, comprising: obtaining a pixelated biometric image; determining a pre-defined fiducial point in said image; extracting a plurality of rectangular arrays of pixels from said biometric image, each rectangular array having a pre-defined location with respect to said fiducial point in said image; storing values at pre-selected points of each rectangular array as part of a template characteristic of said biometric image.

According to a further aspect of the invention, there is provided a method of one-to-many biometric identification, comprising: obtaining a pixelated candidate biometric image; determining a pre-defined fiducial point in said candidate image; extracting a plurality of rectangular arrays of pixels from said candidate biometric image, each rectangular array having a pre-defined location with respect to said fiducial point in said candidate image; comparing values at pre-selected points of at least some of said rectangular arrays of pixels with values at corresponding pre-selected points stored in respect of rectangular arrays previously extracted from a template to derive a metric of similarity.

In the method, the comparing may comprise a correlation operation.

Other features and advantages will become apparent from a review of the following description in conjunction with the drawings.

### BRIEF DESCRIPTION OF THE DRAWINGS

In the figures that disclose example embodiments of the invention:

FIG. 1A is a block diagram of an enrollment method in accordance with this invention;

FIG. 1B is a block diagram of an identification method in accordance with this invention;

FIG. 2 is a diagram detailing the first screening method of FIG. 1;

FIG. 3 schematically illustrates certain steps in the method of FIG. 1;

FIGS. 4, 5, 6A, 6B, 7 to 9, 10A and 10B are schematic illustrations of the approaches to obtain first screening score for fingerprint identification;

FIG. 11 is an exemplary scatter plot used to fuse screening scores;

FIG. 12 is a block diagram for illustrating fingerprint identification using multiple fingers;

FIG. 13 is a schematic diagram illustrating a method for the second screening of the method of FIG. 1; and

FIG. 14 is a block diagram of an exemplary system for undertaking the method of FIG. 1.

### DETAILED DESCRIPTION

1. Overview

In a one-to-many fingerprint access control system, users are first enrolled. On enrollment of a user, one or more images of a fingerprint of the user are obtained and these images are used to create a template which is stored in a database. An individual who attempts access to the system provides one or more fingerprint images which are compared against all of the templates in the database. Based on the results of this comparison, a decision is made to either grant or deny access to the individual.

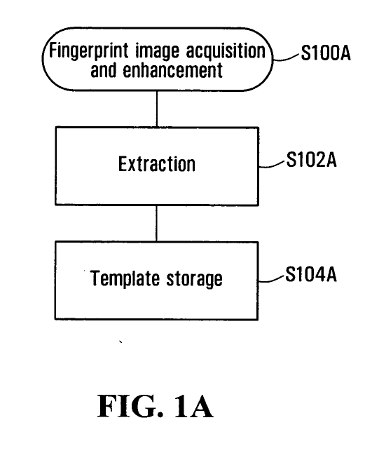

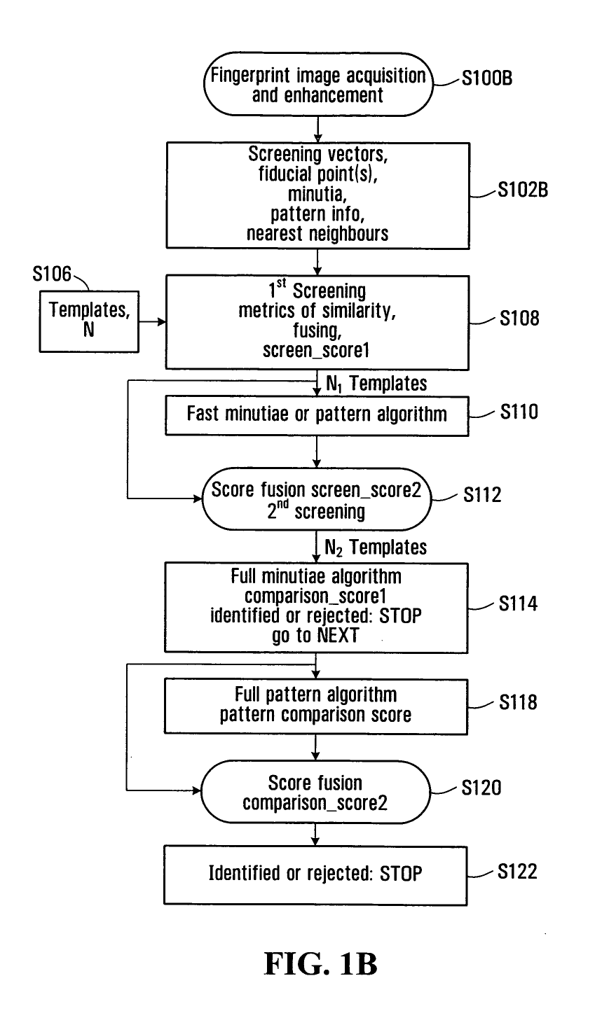

A high level overview of a method for fingerprint identification which may be used in access control is presented with reference to FIG. 1A, which illustrates steps taken in fingerprint enrollment and FIG. 1B, which illustrates steps taken in fingerprint identification. With reference to FIGS. 1A and 1B, any fingerprint identification or verification system starts with fingerprint image acquisition followed, in most cases, by image enhancement (S100A, S100B). These steps are comprehensively described in the art. Image enhancement usually implies noise removal, fingerprint ridge reconstruction, removal of creases and small scars, and separation of the area of the fingerprint from background. There are many fingerprint image enhancement algorithms available in the art. In most cases minutiae based algorithms require higher quality and resolution than pattern based algorithms such that image enhancement for minutiae based algorithms is typically much more time consuming. Fortunately, for a one-to-many system, image enhancement is needed only once during identification and, therefore, does not unreasonably slow the entire process. Enhancement algorithms that equalize the width of fingerprint ridges and grooves, thus making the fingerprint pattern look like a local sine wave, are particularly advantageous for the subject invention. Such patterns are illustrated in the ANSI/INCITS 377 standard, the contents of which are incorporated herein by reference.

The next step involves extraction of various features of the fingerprint image and generation of data from these features (S102A, 102B). As described more fully hereinafter, this step may produce (translation invariant) screening vectors, fiducial (or reference) points, fingerprint minutiae information, pattern information fields, and a list of templates for other enrolled fingerprints which are the nearest neighbors to the subject fingerprint image. The extraction of the data and writing the data into storage in a compressed format as a template (S104) basically concludes enrollment.

Like image enhancement, feature extraction can be time consuming. Be that as it may, it is done only once for each image. Feature extraction may be similar for both enrollment and identification, but there may also be differences. For example, on enrollment, some data may be quantized and/or otherwise compressed to make the template smaller, some data may be pre-calculated and stored into the template to allow faster identification, and some calculations may be done with a more advanced version of the algorithm to provide higher accuracy, since more time is available during enrollment. Additionally, one or more of the comparison algorithms may be inherently asymmetric. By asymmetry we mean that a comparison of fingerprint A vs. fingerprint B usually produces a different comparison score than does a comparison of fingerprint B vs. fingerprint A. The asymmetry is more characteristic for pattern based algorithms as opposed to minutiae based algorithms. For the sake of clarity, though, we will not distinguish enrollment feature extraction from identification feature extraction at this point.

The two biggest challenges in identification for a 1:˜30,000 access control system are speed and accuracy. The system should be able to perform up to 30,000 identifications within a few seconds in a relatively low computational power/memory/storage processor, such as a DSP. This itself is very problematic. There are high speed minutiae based algorithms, though, that can at least theoretically perform this task (we do not consider difficulties of the DSP implementation at this point). However, there is an accuracy problem: if we compare a candidate fingerprint against ˜30,000 templates each time, we must guarantee that an attacker will have a low chance to get through the system, in other words, that the one-to-many False Acceptance Rate (FAR) is low. So let us assume that this FAR is set to 0.5%, i.e. an attacker has 1 in 200 chance to obtain false acceptance. What is the equivalent FAR for a 1:1 verification system? The answer is simple: since the attacker has 30,000 chances to obtain a false acceptance, the 1:1 FAR should be set to 1/(30000×200), which is 1 in 6,000,000. For such a FAR, the False Rejection Rate (FRR), i.e. a probability that a legitimate user is rejected, may skyrocket to 20%-30% or even much more, which is unacceptable for access control applications. We believe this FAR/FRR estimate is realistic for a high speed minutiae algorithm.

As a solution to the accuracy problem, we propose the use of several orthogonal algorithms in sequence and/or in parallel. By orthogonal, we mean the comparison score distribution for a given algorithm is statistically independent of the comparison score distributions of the other algorithms. A good example of orthogonal algorithms is a pattern based algorithm and a minutiae based algorithm. The former matches the entire fingerprint pattern or substantial parts of the pattern while the latter is focused on selected minutiae points (i.e., those that are the most characteristic of a fingerprint). If a candidate fingerprint image is compared against templates in the database with two or more orthogonal algorithms in sequence, the first one may screen out, for example, 90% of all templates. Consequently, only the remaining 10% of the templates pass to the next algorithm(s). Since the second algorithm is statistically independent from the first, the foregoing 1:1 FAR requirement may be relaxed by a factor of 10, i.e. to 1 in 600,000. At such a FAR, the realistic FRR can be of the order of 10% or less, which is acceptable for an access control system. Advantageously, the first screening algorithm is the fastest one and does not bring a high FRR penalty. We consider an FRR on the order of 1% acceptable. In general, each subsequent algorithm should have a better accuracy than the preceding one. Each algorithm usually operates in a different FAR/FRR range. Thus, for example, the first algorithm may have an FAR of 10% (the percentage of templates released to the second step) and an FRR=1%; for the second algorithm the FAR may be 1% and the FRR=2%, etc., such that the total FRR through all screening stages is of the order of 10% or less. It is also expected that each subsequent algorithm will be slower than the preceding one.

Yet another advantage of running a series of orthogonal algorithms is that their comparison scores may be fused, which results in better accuracy. In known approaches, comparison scores are normally fused when the algorithms are run in parallel. (We do not mean that the actual implementation must necessarily be parallel in processing.) In the present invention, the scores of two or more consecutive algorithms can be fused—i.e. the score of the preceding algorithm can be retained to be fused with the subsequent algorithm. This is in contrast to known fingerprint identification systems where the scores of preceding stages of the algorithm are usually dumped.

Ideally, the first screening algorithm should screen out the vast majority of all templates (we expect 90%) with a low FRR (of the order of 1% or less) at a very high speed, and this first screening algorithm should be highly orthogonal to the subsequent algorithms.

Classification techniques have been used as a first screening step. One such technique classified a global fingerprint pattern with respect to so called Henry classes (see, for example, “Advances in Fingerprint Technology”, Ed. by Z. R. Lee and D. P. Zhang, New York: Elsevier, 1991, which we incorporate herein by reference). There are eight known Henry classes; however, a majority of human fingerprints fall into a fewer number of classes. The main problem with this classification technique is that the misclassification error rate can be too high (i.e. when a fingerprint is assigned to a wrong class either on enrollment or on identification). This type of error significantly increases for a smaller area fingerprint sensor, yet such sensors are often used in an access control system. Another known classification technique is called clustering. On enrollment, all templates are grouped into clusters by some “supervised” or (more often) “unsupervised” clustering algorithms. On identification, the candidate image is assigned to one or more of these clusters, thus reducing the number of templates searched. The drawback of the clustering techniques is that it also has a high misclassification error rate.

It is believed better results may be possible with a pattern based algorithm for the first screening stage. With further reference to FIG. 1B, the first screening algorithm calculates a first screening score, Screen_score1 between the candidate image and all N templates (S108) (i.e. the entire universe of templates), which are read in from storage and decompressed (S106). With the pattern based method described hereinafter, the comparison rate may be very high, such as ˜1,000,000 comparisons/sec in a PC environment and ˜100,000 comparisons/sec in embedded systems (e.g., in a DSP). The first screening algorithm may output N₁ templates (that is, a second, smaller universe of templates) which may be ˜10% or less of all templates) to the next step with a low FRR of about 1% or less. More specifically, a few metrics of similarity may be calculated between each of the (translation invariant) screening vectors of the candidate image and the (translation invariant) screening vectors of each of the templates in the database. These few metrics of similarity are fused into first screening score, Screen_score1. A high speed of comparison may be achieved because computationally efficient comparisons, such as a vector dot product, may be used, and because translation invariance of the screening vectors reduces the size of the search space. The decision which template is to be output to the next step is based either on comparison of Screen_score1 with a pre-determined threshold or on the condition that Screen_score1 is among the top N₁ scores. The former method is faster but the latter one usually provides a better overall accuracy.

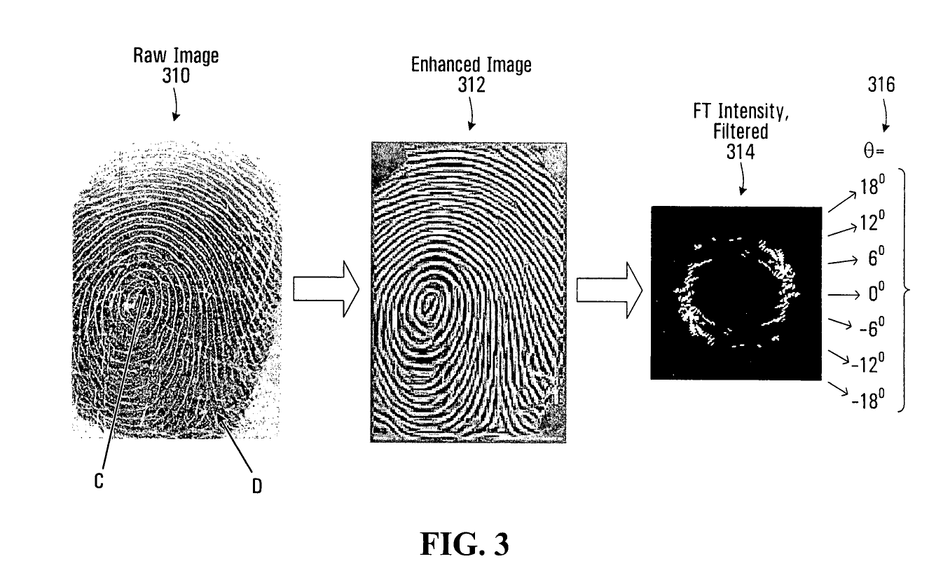

The second screening algorithm (S110) runs a fast minutiae or fast pattern based algorithm for the N₁ templates. Fast minutiae based algorithms are known; see, for example, the book “Biometric Systems—Technology, Design and Performance Evaluation” by J. L. Wayman, A. K. Jain, D. Maltoni, and D. Maio, Springer, 2005, which is incorporated herein by reference, as are the references therein. One suitable fast minutiae based algorithm uses a fingerprint fiducial point, such as the fingerprint “core”, C (FIG. 3), or “delta”, D (FIG. 3), to align the candidate minutiae information with a minutiae part of any of the N₁ templates. An advantageous fast pattern based algorithm will be described hereinafter.

The fast minutiae or fast pattern based algorithm computes a screening metric of similarity for the candidate image against all N₁ templates. This metric of similarity is fused with Screen_score1 from the first screening step to obtain Screen_score2 (S112). As already mentioned, score fusion utilizes the orthogonality of two screening algorithms to result in better accuracy. Based on Screen_score2, N₂ templates are output to the next step. They normally represent 0.1%-1% of all templates, N, meaning that 99%-99.9% of templates have been screened out. The expected FRR penalty after the second screening stage may range from 1% to 10%. This FRR number depends on many factors, such as the type of fingerprint sensor, image quality, computational power, cooperative/uncooperative users, etc. These factors are not significantly different from any other fingerprint or biometric system.

The next step involves running a full minutiae based algorithm for N₂ templates. Full minutiae based algorithms are known: see, for example, the aforementioned book by J. L. Wayman et al. The difference between fast and full minutiae algorithms is that the latter ones search through the entire minutiae space including all possible shifts, rotations, etc., while the fast minutiae algorithms may use shortcuts, such as using fiducial point(s), to align images for comparison. It is obvious that the full minutiae algorithms provide better accuracy but are significantly slower.

The full minutiae based algorithm computes a matching score, Comparison_score1, for the candidate image against all N₂ templates (S114). At this step, the system is already capable of identifying or rejecting the candidate image. Thus, if certain identification criteria are met, the candidate is identified (i.e., the candidate fingerprint image is judged to match one of the templates) and if, on the contrary, certain rejection criteria are met, the candidate is rejected (i.e., the candidate fingerprint image is judged to not match any template in the database). If the answer is inconclusive, the identification process continues.

There are a number of ways to set the identification/rejection criteria. The most common is to set a high identification threshold, Thr_high1, so that if Comparison_score1 exceeds it for one template, the candidate image is identified as representing the same finger as used to create the template. Similarly, a low (rejection) threshold, Thr_low1, is also set, so that if Comparison_score1 is below it for all the templates, the candidate is rejected. A drawback of this approach is that Comparison_score1 may exceed Thr_high1 for more than one template, even if each finger is represented in the database by only one template. A wrong template that generates a high Comparison_score1 may be encountered before the legitimate one (i.e., the template derived from the same finger as the candidate image), in which case an early out may be forced, so that the candidate will be wrongly identified. We call such an event “false identification” to distinguish it from the more common notion of false acceptance. In other words, false identification means that a legitimate candidate image (i.e. an image represented by a template in the database) is identified as matching someone else's template. On the contrary, false acceptance occurs when an attacker (i.e. a person whose fingerprint is not enrolled in the database) is identified as matching someone's legitimate template. Unlike false acceptance, false identification does not mean a security breach of the access control system. However, it certainly is a malfunctioning of the system if, for example, the system is also supposed to control time and attendance. To reduce the false identification rate, we prefer to set the identification criteria in such a way that Comparison_score1 is computed for all N₂ templates, and the template with the maximal Comparison_score1 is found. If this maximal Comparison_score1 also exceeds Thr_high1, then and only then this template is identified as belonging to the candidate.

If the maximal Comparison_score1 does not exceed Thr_high1, the result is declared inconclusive, and the algorithm passes to the next stage. However, only those templates, if any, that were not rejected under the rejection criteria are output to this next stage. We expect the number of templates output from the full minutiae based algorithm to be in the order of a few. The next stage is performance of a full pattern based algorithm (S118). Unlike minutiae based algorithms, not many pattern based algorithms are available. One suitable pattern based algorithm is that described in U.S. Pat. No. 5,909,501 to Thebaud, the contents of which are incorporated herein by reference. (This algorithm won two international fingerprint verification competitions in a row, FVC2002 and FVC2004, over all other algorithms—31 in 2002 and 67 in 2004.) It is feasible to run this algorithm as a final stage of identification where only a few templates remain.

The full pattern based algorithm computes a score between the candidate image and the remaining templates. Then this score is fused with Comparison_score1 from the previous stage to obtain Comparison_score2 (S120). The score fusion will make this final stage of the algorithm even more accurate. Identification criteria are then applied (S122). Specifically, similar to the full minutiae based algorithm, the template with maximal Comparison_score2 is found. If this maximal Comparison_score2 exceeds a pre-determined threshold, Thr_high2, then this template is identified as belonging to the candidate. If it is below Thr_high2, the candidate is rejected. The identification is then completed.

It will be obvious to anyone skilled in the art that the identification algorithm as described may be modified in certain circumstances, as for example, where it is desired to make the algorithm faster at the expense of accuracy, or more accurate at the expense of speed. Also, where a smaller number of templates are enrolled (e.g., ˜5000), simpler versions that do not require all the stages of the algorithm can be used. For example, with a smaller database of templates, it may be appropriate to omit the (fast minutiae or pattern based) second screening algorithm (S110), such that the full minutiae algorithm will follow the first screening algorithm. The full pattern algorithm can be also omitted given a smaller number of templates at the cost of accuracy. Alternatively, an all pattern based (no minutiae based) algorithm is possible: after the first screening stage, the fast pattern based algorithm does the second screening, and the final identification is done by the full pattern based algorithm. This version works well for a number of templates in the range 500 to 1,000 or so. Other simplifications include so called early exits, when the identification process is stopped if one of the intermediate scores (e.g., Comparison_score1) exceeds a high threshold (not necessarily the same as Thr_high1). This is feasible if the application allows a higher false identification rate. Yet another modification includes a so called “shortcut option”, when Screen_score1 or Screen_score2 for all the templates are sorted, and the templates with the top Screen_score1 or Screen_score2 enter the next stage (a full minutiae or pattern algorithm) first. It is likely that those top templates will also have a high Comparison_score1 or Comparison_score2, so that the identification process may be immediately terminated upon exceeding a high threshold (not necessarily the same as Thr_high1 or Thr_high2). This will result in substantial time saving for a majority of users (80%-90% of users, in our experience).

2. First Screening Stage

The first screening is in large part responsible for extending the search capability from 1000-2000 templates to on the order of 30,000 templates. The requirements to the first screening stage are very tough: it must screen out at least 90% of all the templates; the FRR penalty should be very low (<˜1%); the algorithm should be orthogonal to all subsequent algorithms; and the screening should proceed at a very high speed. In other words, we want to reduce the number of templates by a factor of ten or more without a big penalty both in terms of overall accuracy and speed.

The first screening can use so called translation invariant screening vectors. Translation invariance means that the vector does not change if the fingerprint moves across the area of interest. This may be true, of course, only if the information content of the fingerprint does not change, i.e. the fingerprint is not cropped. In reality, cropping may occur when a finger is placed onto a relatively small sensor area. In this case the vectors are approximately translation invariant. In fact, the fingerprint changes at each impression anyway due to the other factors, such as rotations, distortions/deformations, quality/contrast variations, etc., so translation invariance will always be approximate. Translation invariance excludes fingerprint shift from the search space which results in a substantial time saving. Screening vectors can be made translation invariant either by applying a transform to the fingerprint image that is inherently translation invariant, or by just extracting data relative to a natural fingerprint alignment feature (such as the core or delta of the fingerprint).

Three types of translation invariant feature vectors may be employed: Fourier intensity vectors, gradient magnitude vectors, and gradient direction vectors. The former is inherently translation invariant, while the latter two are linked to a fingerprint fiducial point(s). These vectors may form a part of each template. They may be stored in a quantized/compressed format, if necessary, and some values, such as a vector norm, may be pre-computed.

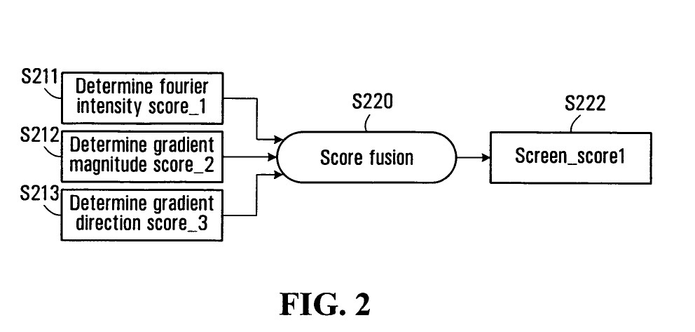

On identification, these same translation invariant screening vectors are extracted from the candidate image. Next, referring to FIG. 2, for each template, a metric of similarity, or a score, with a corresponding candidate vector counterpart is calculated (S211, S212, S213), so that three scores—a Fourier intensity score_1, a Gradient magnitude score_2, and a Gradient direction score_3—are obtained. This may be accomplished at very high speed, because each metric of similarity usually involves computation of a vector dot product or a vector distance. Those calculations are very efficient since there is no search across different shifts, and the computational optimization is available both through hardware, such as Field Programmable Gate Arrays (FPGAs), and software means.

The three scores, Fourier intensity score_1, gradient magnitude score_2, and gradient direction score_3, are then fused (S220) to obtain the first screening score, Screen_score1 (S222). This score is used to screen out the majority of templates, as described hereabove in Section 1.

2.1. Fourier Intensity Vectors

With reference to FIG. 3, the incoming raw fingerprint image 310 (obtained during enrollment or during identification) may undergo extensive image enhancement to produce an enhanced image 312. The fiducial points, such as core C and delta D, may be found. If the fingerprint image is too big, a smaller part of the image may be extracted; for example, relative to a fiducial point. Next a Fourier transform (FT) of the extracted image is performed, and the FT intensity is calculated. It is known that the FT intensity is translation invariant, and so is any feature based on the FT intensity. It may be noted that the FT can be performed on either the enhanced image 312 or the raw image 310. Both methods have their pros and cons, with the deciding factor being overall system performance. One or more filters are applied to the FT intensity to result in filtered FT intensity 314. A basic filter may remove DC components not bearing useful information and other more sophisticated filters, as for example a Wiener filter, may be applied in order to enhance or suppress certain Fourier components.

On enrollment, the user may be asked to provide more than one (usually three to six) fingerprint impressions, and then an optimal composite filter is created out of those images. This optimal composite filter may be used as described in the article titled “Optimal Trade-off Filter for the Correlation of Fingerprints” by D. Roberge, C. Soutar, and B. V. K. Vijaya Kumar, Optical Engineering, v. 38, pp. 108-113, 1999, which we incorporate herein by reference. For the purpose of the present invention, the FT intensity of this composite filter is then taken. On identification, normally one fingerprint image will be captured, and the optimal filter in this case coincides with the Wiener filter. This technique allows tuning of the filter parameters to achieve a tradeoff between discrimination and tolerance, which, in turn, results in better overall accuracy.

On identification, after the (filtered) FT intensity is obtained, a few rotated versions of it may be generated, as shown in FIG. 3 at 316. Fingerprint rotation is one of the main sources of errors, therefore, for most systems, it is desirable to compensate for rotation. This can be done on identification via a brute force search through the appropriate angle range and increment (e.g., a+−18° range with 6° increments, as shown in FIG. 3). The original image does not have to be rotated, it is enough to rotate the FT intensity. The screening vectors on identification will be extracted from all rotated versions of the FT intensity. This increases the processing time but adds rotation tolerance to the system, resulting in better accuracy.

Three approaches are contemplated to obtain the Fourier intensity vectors; these three approaches are described here following (in sections 2.1.a to 2.1.c). Of these, only the last described (in 2.1.c) is rotationally invariant.

2.1.a. Randomization of Fourier Intensity

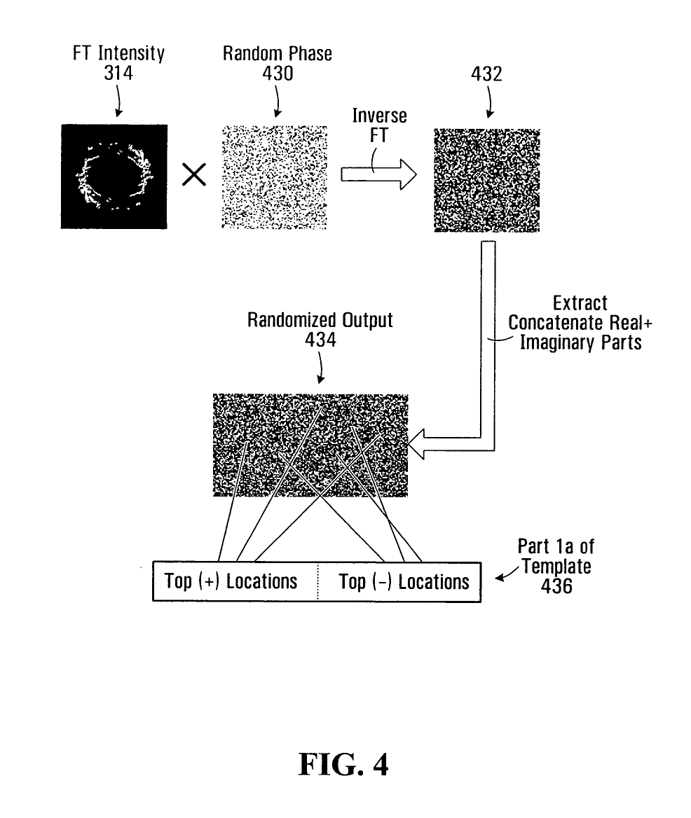

With reference to FIG. 4, the filtered FT intensity 314 obtained on enrollment is multiplied by a complex random phase-only function 430. This function is pre-computed and stored in system memory, and is the same for all the templates and for the candidate images. Then the inverse Fourier transform is performed to obtain a complex pseudo-random array 432. A central part of the complex array is extracted, and real and imaginary parts are concatenated to obtain a real randomized output array 434. This processing is done to spread the information contained in the FT intensity in a more uniform way. It is known that the FT intensity of a fingerprint often manifests a few high peaks concentrated in a narrow frequency range, while the rest of the information is less visible, though important. In contrast, the randomized output array has an approximately equal number of high (in absolute value terms) positive and negative peak valued pixels. When the fingerprint changes from one impression to another, these peaks tend to be more robust than the rest of the pixels in the array.

The final step of enrollment for this embodiment includes finding a pre-determined number (for example, 100) of top positive and top negative locations (i.e., pixel values) 436 in the randomized output array, and storing these locations as a translation invariant screening vector in the template.

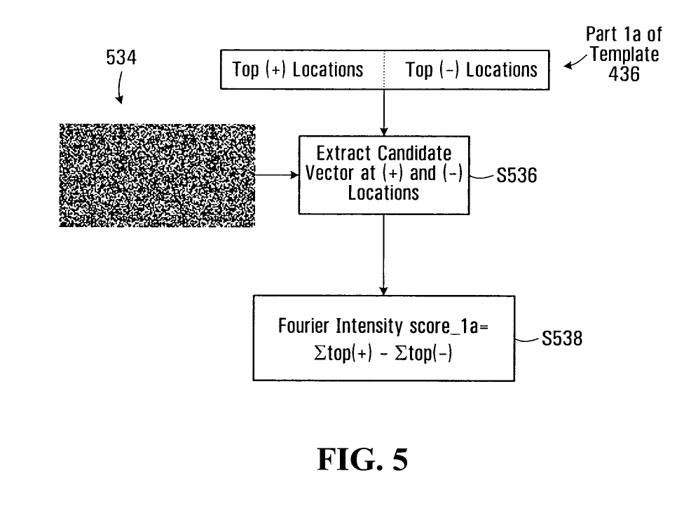

With reference to FIG. 5, the first step of identification includes reading the stored top positive and top negative locations 436 from a template. The candidate image is processed the same way as described in conjunction with FIG. 4 to obtain a real randomized output array 534. If a number of rotated versions of the FT intensity are created (FIG. 3), there will be the same number of randomized output arrays for the candidate image. A candidate screening vector is extracted from each candidate randomized output array at the locations specified in the template (S536). In other words, the template provides the set of pixel locations and the candidate randomized output array supplies the pixel values at these pixel locations. Then the screening score, score_1a, for this embodiment is calculated as the sum of these pixel values:
score_{—}1a=Σtop(+)−Σtop(−)
where top(+) and top(−) are the pixel values of the candidate randomized output array at the top positive and top negative locations for the template (S538). It is expected that the larger the value of score_1a, the better the match. If there are a few rotated versions of the randomized output array, the maximal score over the rotation angles is taken for this particular template.
2.1.b. Wedges and rings of Fourier intensity

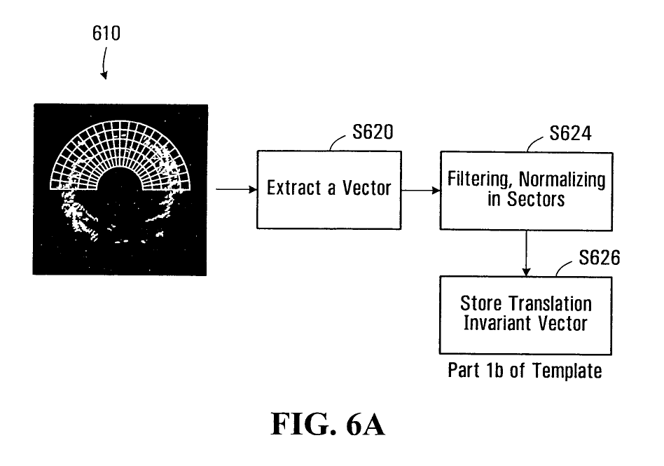

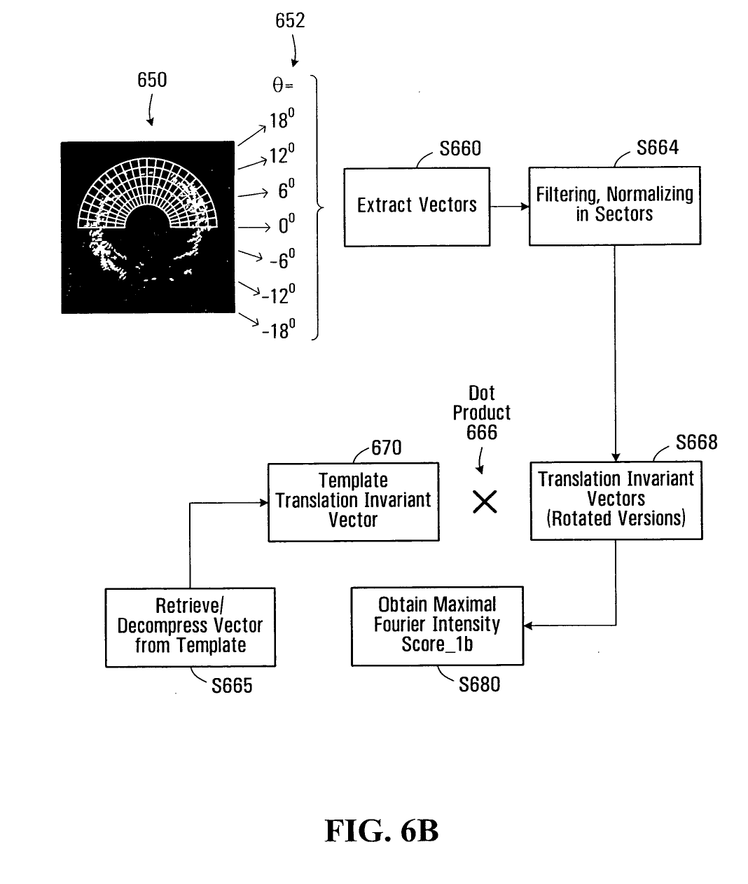

With reference to FIG. 6A, on enrollment, the filtered FT intensity obtained from the fingerprint image of an enrollee is divided into a number of “wedges” and “rings” as shown at 610. In the example shown, there are 24 “wedges” in each of 5 “rings”, yielding a total of 24×5=120 wedge-shaped cells. The “wedges” and “rings” are positioned in such a way that they cover the most important range of Fourier frequencies for fingerprints. Since the FT intensity is symmetric relative to the center (coinciding with the DC component), only half of the FT intensity array (in the example shown in FIG. 6A, the upper half) should be taken into account. The coordinates of pixels for each cell are pre-computed and stored in memory. The average FT intensity components within each cell is calculated to obtain the translation invariant screening vector for this embodiment (S620). For example, if a cell encloses fifty pixels, the sum of the intensity values of each of the pixels may be determined and this sum is then divided by fifty to be taken as one of the components of the vector. In the example shown in FIG. 6A this vector will have 120 components. In general, it is feasible to have from about 18 to about 300 components in the vector. The extracted vector may further undergo some filtering and normalization (S624). The filtering may include removing the mean and/or applying a 1D phase-only or Wiener filter. The normalization may include dividing each vector component by variance. Both mean and variance can be estimated either globally (i.e. for the entire vector) or in wedge sectors, such as, for example, each sector of 30° has its own mean and variance. The processed vector may be further quantized/compressed before being stored as part of the template (S626).

With reference to FIG. 6B, on identification, for each of the rotated versions 652 of the FT intensity 650, the average FT intensity within each cell is calculated to obtain the translation invariant screening vector (S660). Each vector may then be filtered and normalized (S664). However, this processing is not necessarily the same for identification as it was for enrollment (i.e. the processing can be asymmetric). An enrolled vector is then retrieved from a template and decompressed (S665) and the dot product 666 between the candidate vector 668 and the template screening vector 670 is calculated to obtain the screening score, score_1b, for this embodiment. If there are a few rotated versions of the FT intensity, the maximal score over the rotation angles is taken for this particular template (S680). This same process is then repeated for each of the other templates in the database.

2.1.c. Circular Harmonics Expansion of Fourier Intensity

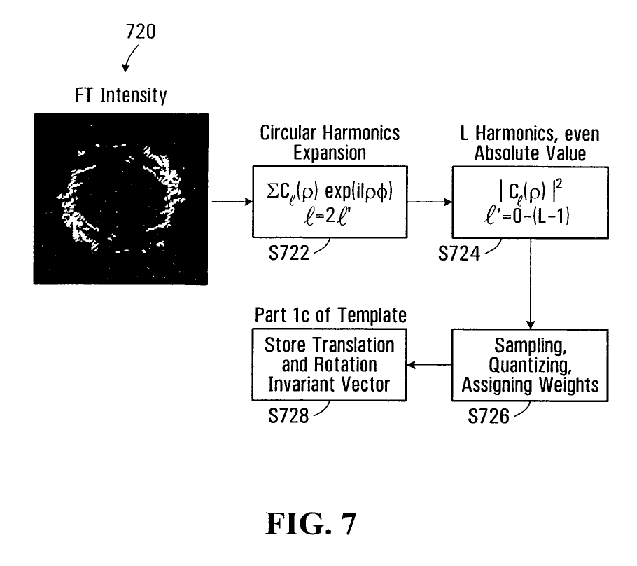

With reference to FIG. 7, on enrollment, the filtered FT intensity, P, of the enrollee fingerprint 720 is expanded into a series of so called circular harmonics (S722),
P(ρ,φ)=ΣC₁(ρ)exp(i1ρφ),
1=2l′
where ρ, φ are the polar coordinates of the FT intensity, 1 is a circular harmonic number (it is even for a symmetric FT intensity, so that 1=21′), C₁(ρ) is a complex magnitude of 1^{th} circular harmonic, and i is a complex unit. Then the square of the absolute value of the complex magnitude is taken, |C₁(ρ)|², and L lowest order circular harmonics are retained, i.e. 1′=0−(L−1) (S724, FIG. 7). The squares of the absolute values are rotation invariant, meaning there is no need for a rotation search for this embodiment. Each circular harmonic magnitude depends on the radial coordinate, ρ, so that the retained harmonics should be sampled over ρ. Since harmonics with higher L bring more discrimination but less tolerance, it is reasonable to assign a certain weight to each I^{th} harmonic. Then the sampled and weighted |C₁(ρ)|² values for I′=0−(L−1), I=21′ may also be normalized, and quantized/compressed (S726) and stored in the template (S728) as translation and rotation invariant screening vectors.

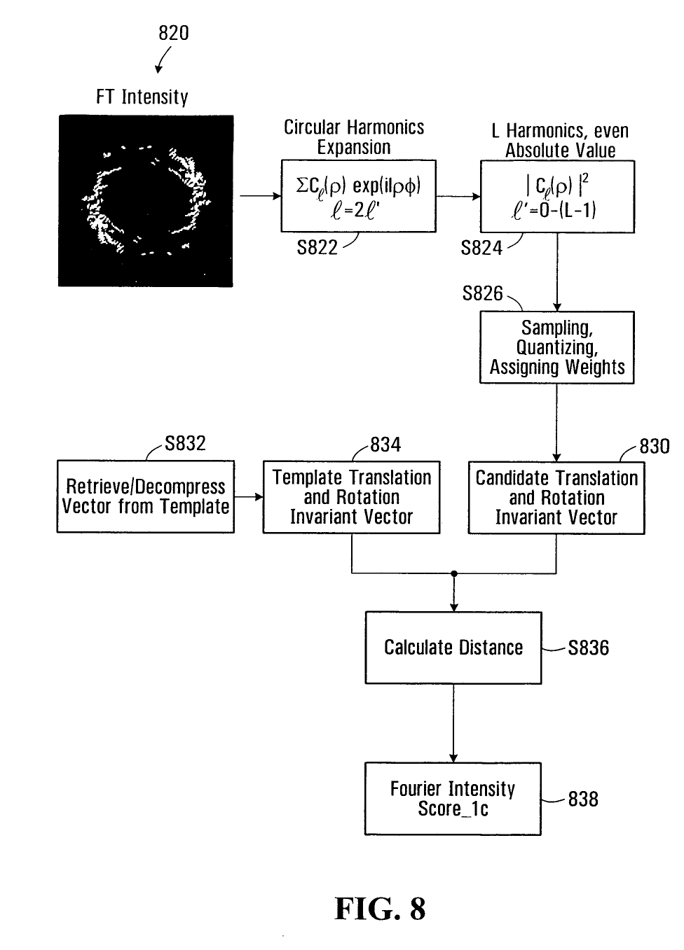

Referring to FIG. 8, on identification, a rotation and translation invariant screening vector is obtained from the candidate image 820 basically in the same way as shown in FIG. 7 (S822, S824, S826). Next, a corresponding vector from a template is retrieved and decompressed (S832) and a distance is computed (S836) between the template vector 834 and the candidate vector 830 to obtain the Fourier intensity screening score, score_1c 838, for this embodiment. The process then repeats for each of the other templates in the database.

It depends on the system and application requirements which embodiment (2.1.a, 2.1.b, or 2.1.c) will be used to obtain the Fourier intensity score, score_1. For example, if a high range of rotation angles is expected (such as where a large area fingerprint sensor does not have a finger jig or a guide), then the Embodiment 2.1.c (Circular Harmonics) might be preferred. If there are limitations on system memory, the Embodiment 2.1.b may be preferred. The Embodiment 2.1.a may be the fastest to calculate the identification score, since the score computation includes additions only (no multiplications) and, therefore, is easy to implement within special hardware, such as an FPGA.

2.2. Gradient Field Vectors

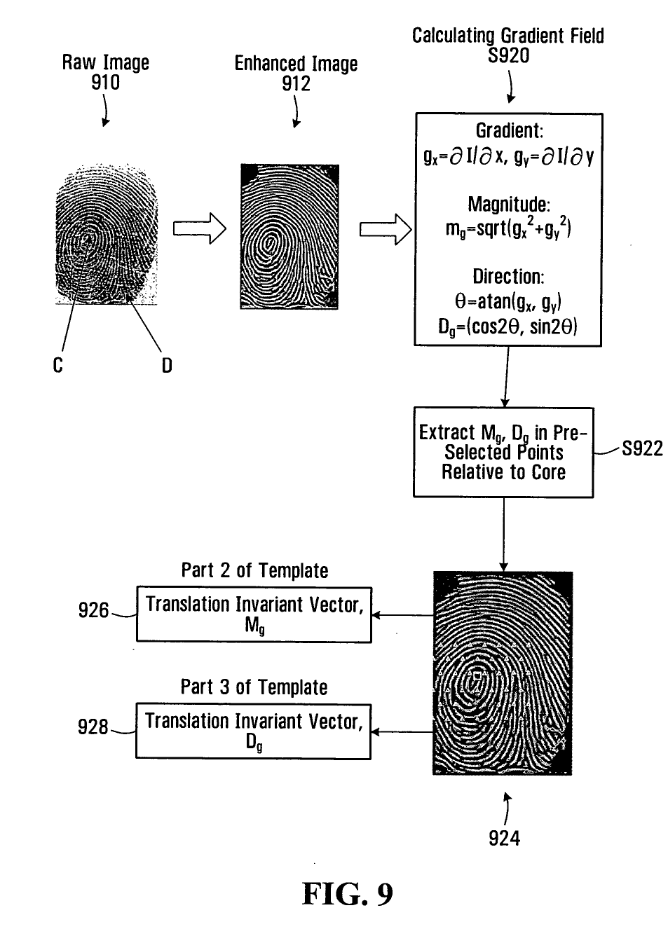

With reference to FIG. 9, the incoming raw fingerprint image 910 undergoes extensive image enhancement. After the 2D enhanced image 912 is obtained, which we denote I(x, y), the gradient field is calculated for each pixel, such as
gₓ=∂I/∂x,g_{y}=∂I/∂y
where gₓ, g_{y} are the x and y components of the gradient.

It is not a trivial problem to digitally compute the gradient of a sampled fingerprint image with sufficient accuracy. A few methods are available: 1D discreet formulas (Lagrange, Newton, etc.); 2D differentiation formulas (Sobel, Roberts, etc.); and using a Fourier method. The choice depends on the system and application requirements. The gradient field is used to find the fiducial points, such as core and delta, in the enhanced image.

The next steps include obtaining the gradient magnitude, M_{g},
M_{g}=sqrt(gₓ²+g_{y}²)
and the gradient direction vector, D_{g},
D_{g}=(cos 2θ, sin 2θ),
where
θ=a tan(gₓ,g_{y})
(S920). In another embodiment, the gradient direction vector may also contain the magnitude factor, i.e.
D_{g}=M_{g}·(cos 2θ,sin 2θ)
Both M_{g} and D_{g} undergo some spatial smoothing to alleviate the effect of spurious variations. Note that we use double angle (i.e., 2θ) for D_{g}. This is done in order to accomplish the smoothing properly, i.e., to avoid canceling out the gradient directions of θ and (π-θ).

Next, the gradient magnitude and direction are extracted at a number of pre-selected points located relative to the fingerprint core C (S922). (While the core has been used as the reference fiducial point in this approach, obviously another fiducial point may be chosen instead, if desired.) The selections are shown in the image 924 with the core shown as a white square and the pre-selected points as white triangles. In the example of FIG. 9, there are 42 points (six rows with seven equidistant points each). Each row is shifted in horizontal direction by half the distance between points, thus making the 42-point grid look like a “chessboard”. This may be useful in order to extract more information at the selected points, such as in the case of nearly vertical fingerprint ridges. It is not necessary to extract both gradient magnitude and direction in all 42 points; for example, the magnitude may be extracted at all of the points, while the direction may be extracted at only two or three rows. If one point falls outside the fingerprint area, the magnitude and direction may be assigned to the nearest neighbor within the image, or some average over the nearest neighbors value may be assigned. Note that if the core of the fingerprint image is determined in some other manner than from the gradient field, it would only be necessary to calculate the gradient field at the pre-selected pixels, rather than over all pixels.

After the extraction at pre-selected points (pixels) is completed, the extracted gradient magnitude and the gradient direction values are quantized/compressed separately and stored into the template as vectors 926 and 928, respectively. The translation invariance of those vectors is achieved due to the fact that the points of extraction are always linked to the fingerprint core, which itself is supposed to be reliably found every time.

On identification, the candidate image is processed in the same way as shown in FIG. 9 (at S920, S922) to obtain candidate gradient magnitude and gradient direction screening vectors.

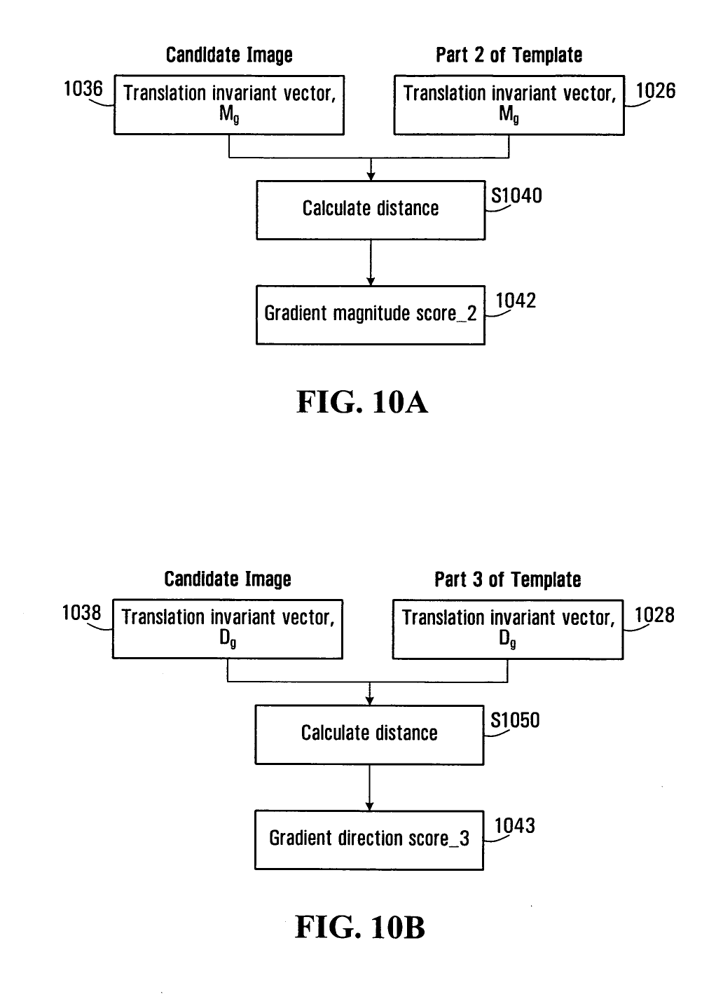

With reference to FIGS. 10A and 10B, template vectors 926, 928 (of FIG. 9) are decompressed to obtain a template gradient magnitude screening vector 1026 and a gradient direction screening vector 1028, respectively. Then the distance between the candidate gradient magnitude screening vector 1036 and the template gradient magnitude screening vector 1026 is calculated (S1040) to obtain a gradient magnitude score, score_2 1042. Similarly, the distance between the candidate and the template gradient direction screening vectors 1028, 1038 is calculated (S1050) to obtain a gradient direction score, score_3 1043. It is obvious that a few rotated versions of M_{g} (1036) and D_{g} (1038) can be obtained for the candidate image to make the system more rotationally tolerant. In this case the maximal score_2 and score_3 over the rotation angle are taken for this particular template. This processing is then repeated for each template in the database.

3. Score Fusion

There are various known methods for score fusion. They usually deal with fusing different biometrics, such as fingerprint and face recognition, or with fusing, for example, multiple finger scores. In general, they are also applicable to fusing the scores from different algorithms, which is the subject of the present invention. The simplest way to fuse scores is to obtain their product. Besides simplicity, this method does not require system training. However, this approach is not preferred as it does not normally provide adequate accuracy for the purposes of the present invention. Another known method uses a weighted sum of two or more scores. The method requires some system training and, for many systems, we do not consider it to be sufficiently accurate. There has been some work using neural networks (NN) and so called Support Vector Machines (SVM). In our opinion, the latter approach works better. But both methods require extensive system training. Further, both methods have the drawback that they are prone to overfitting on the training data set and to subsequent failure on real life testing data.

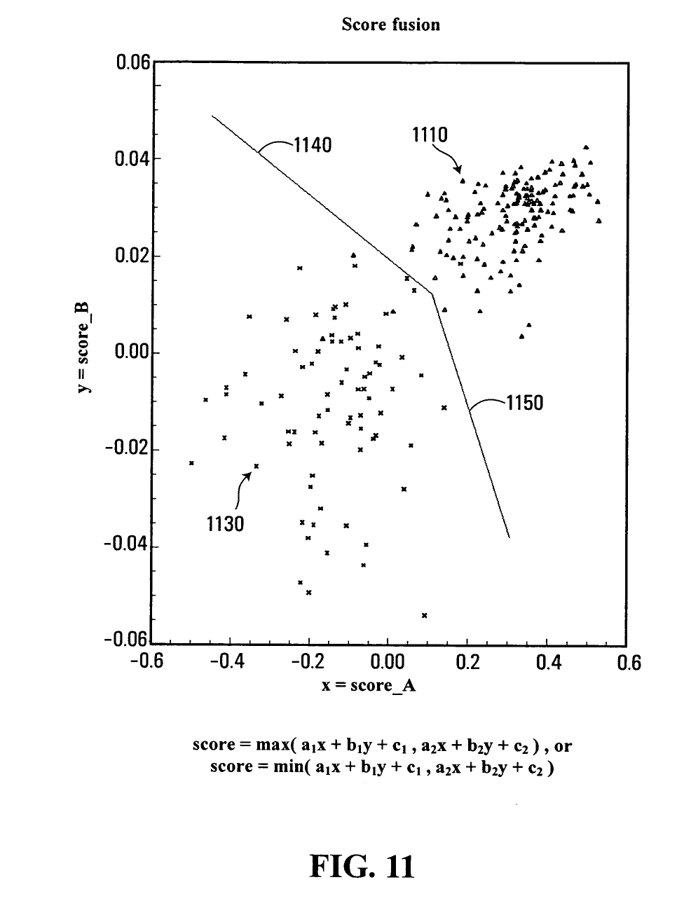

Accordingly, we normally prefer a different approach to the score fusion problem that we call decision boundaries. The approach begins with the enrollment of fingerprint images from a number of individuals (enrollees) to create a database of templates. Next two screening scores, say score_A and score_B, are obtained from a training data set, that is, from a number of test fingerprint images, some of which are images from enrollees, and others of which are images from non-enrollees, i.e., impostors. Of course, it will be expected that the screening scores for most enrollees, when scored against their own template, will be higher than the screening scores obtained by most non-enrollees. Further, it is expected that the screening scores for most enrollees will be lower when scored against other than their own template. FIG. 11 illustrates an exemplary 2D scatter plot of the training data set with each triangle object 1110 representing a (score_A, score_B) pair resulting from a test fingerprint image of an enrollee scored against his or her own template and each cross object 1130 representing a (score_A, score_B) pair resulting from either (i) a test fingerprint image of an imposter tested against a template or (ii) a test fingerprint of an enrollee tested against other than his or her own template. The score pair of an object is represented on the scatter plot by x=score_A and y=score_B. The problem is not only how to separate the triangle object and cross object distributions in the best way, but also how to define a fused score for any (x, y) pair.

With further reference to FIG. 11, we separate the distributions with two or more straight line fragments 1140, 1150. If a₁x+b₁y+c₁=0 and a₂x+b₂y+c₂=0 are the equations of the straight lines 1140 and 1150, respectively, then we propose the fused score be calculated as:
score=max(a₁x+b₁y+c₁,a₂x+b₂y+c₂, or
score=min(a₁x+b₁y+c₁,a₂x+b₂y+c₂)

If the max option is chosen, the separation will be more tolerant, while the min option yields more discriminatory separation. It is obvious that a combination of max and min expressions can be used where there are more than two straight line fragments. It is also obvious that if more than two scores are to be fused, this can be done in a sequential way, such that two scores are fused to obtain an intermediate score, which in turn is fused with the third score, and so on.

4. Identification Using Multiple Fingers

Some high security access control identification systems may require a user to present two or more fingers (rather than one) on enrollment and on identification. It is believed that the accuracy of such a system will significantly improve if the fingerprints obtained from a first finger and a second finger are statistically independent since the probability of error (either FRR or FAR) will be a product of one-finger error probabilities, in other words, much smaller. Unfortunately, the assumption of statistical independence has not been reliably confirmed. Nonetheless, an improvement of accuracy still takes place. And multiple fingers provide another benefit to the identification process of the present invention: screening and, therefore, the entire identification process, can be significantly faster. This is because a smaller FAR means that fewer templates (e.g., 1% instead of 10%) can be output from the first screening algorithm, while the FRR penalty remains the same (˜1%) or lower.

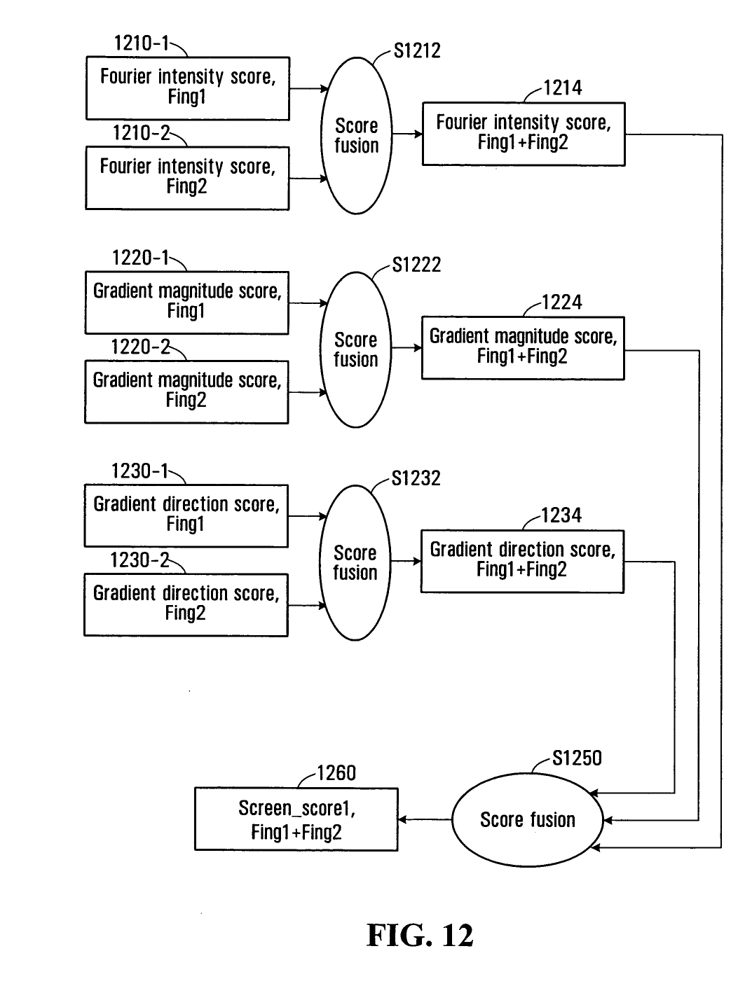

The question that has to be addressed is how to fuse the scores where two or more fingerprints are required. Should Screen_score1 from the first screening algorithm be obtained for each finger by fusing Fourier intensity score_1, gradient magnitude score_2, and gradient direction score_3 for each finger, and then Screen_score1 for first and second fingers be fused together? Or, as shown in FIG. 12, should score_1 1210-1 obtained for the first finger and score_1 1210-2 for the second finger be fused (S1212) into a new score_1 1214 representing the first and second fingers, and the same process be followed for score_2 (see 1220-1, 1220-2, S1222, and 1224) and score_3 (see 1230-1, 1230-2, S1232, and 1234), and then new score_1 1214, new score_2 1224 and new score_3 1234 be fused (S1250) into single Screen_score1 1260? We prefer the latter. In other words, the lowest level score obtained for each finger should be first fused with its counterpart(s) from another finger(s), and only after that, with different type scores. The same approach can be used for the other screening algorithms shown in FIG. 1.

5. Adaptive Classification Technique

In another embodiment of the invention, a novel approach is used that we call adaptive classification. In this approach, all of the enrolled templates are considered as a “club” with certain links established between its members such that, in consequence, it is expected an impostor would not have those links. In other words, a decision whether to grant a candidate image access (i.e. to be positively identified) depends not only on the individual candidate-template scores but also on scores produced with other templates in the club. We call this system a classifier, but, unlike a conventional classifier, a template or a candidate is not assigned to a certain class. We use the classification technique to obtain a classification score between a candidate image and each of the templates which can be used to improve the screening process.

More specifically, on enrollment, the translation invariant screening vectors described hereinbefore are used to compute a distance between each pair of templates. This distance is not necessarily related to Screen_score1. The components of the translation invariant screening vectors may be re-normalized, so that a contribution of each screening vector (and recall there are normally three for each template) is adequate (i.e. not over- or underestimated). The only requirement to the distance, d, is that it must satisfy an inequality
d(A,B)≦d(A,C)+d(B,C)
where A, B, and C are any given objects, in our case, the translation invariant screening vectors.

After the distance between any given template (for example, template Y) and all the other templates is computed, the list of the nearest neighbors is created for the template Y. Normally, not more than k nearest neighbors are put onto the list. Some lists may have less than k nearest neighbors if the distance to the rest of the templates is too large. This list of k nearest neighbors is stored into the template Y as a new part of the template. The same is done for all the templates in the database. Each time a new fingerprint is enrolled into the database, this procedure is repeated, such that the procedure is adaptive. It is necessary to find the nearest neighbors not only for the new template but to update the lists for all (or at least some) other templates, since the new template may affect the lists for other templates. If the number of the templates in the database is large, this procedure can be done offline (e.g., overnight).

On identification, the translation invariant screening vectors are obtained from the candidate image and re-normalized. Then the distance from all the templates in the database is computed, and the list of k nearest neighbors is created for the candidate. Then this list is compared with all the template lists of the nearest neighbors to obtain another metric of similarity, which we call a classification score. This score may be defined, for example, as a percentage of the nearest neighbors contained in both candidate and template lists. In the next step, the classification score is fused with Screen_score1 obtained by the methods described hereinbefore. The resulting new first screening score is used as a decision metric for screening to further improve the time performance and/or accuracy of the system.

In yet another version of this embodiment, the candidate list of the nearest neighbors is compared not only with a template list of the nearest neighbors but also with second order neighbors (i.e. with the nearest neighbors of the nearest neighbors). The second degree classification score is obtained and fused with the first degree classification score and the resulting score is then fused with Screen_score1.

6. Second Screening: Fast Pattern Based Algorithm

As mentioned in the Section 1, the first screening algorithm may be followed by a second screening using a fast minutiae or fast pattern based algorithm. This further reduces the number of templates that will enter a full minutiae or full pattern based algorithm. Fast minutiae based algorithms are known. On the other hand, there is not, to the best of our knowledge, a good performing fast pattern algorithm suitable for the second screening. Such an algorithm may be a good choice for use by itself (i.e., with no other screening algorithms) for an access control identification system with a medium number of templates and with limited memory (since image processing and enhancement for a minutiae based algorithm may be too memory consuming). Here we present a pattern based algorithm for the second screening stage which we call a “tile” algorithm.

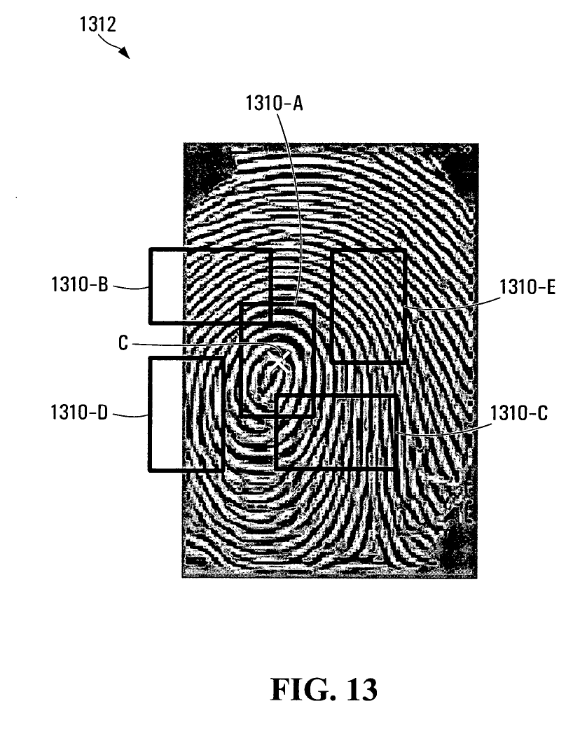

The incoming raw fingerprint image undergoes extensive image enhancement in basically the same manner as described in the previous sections. The fiducial points, such as the core and delta, are found. We will consider a core as the reference fiducial point in this section. With reference to FIG. 13, a few rectangular arrays, or “tiles” 1310, are extracted from the enhanced image 1312. Their centers are globally pre-defined with respect to the core, C. The “tile” aspect ratio is usually between 1.5 and 2. In the preferred embodiment, we extract five “tiles” 1310. The central one 1310-A is located at the core, while two horizontal 1310-B, 1310-C and two vertical “tiles” 1310-D, 1310-E are located in the surrounding areas. On enrollment, the “tiles” may undergo some filtering, for example, using a phase-only, a Wiener, or an optimal (in case of multiple fingerprint impressions) filter. Then the “tiles” are quantized (normally up to 4 bits/pixel) or even binarized. Then a sub-array may be extracted from each “tile” at pre-defined pixel locations. The total number of pixels extracted may be of an order of 25% of all “tile” pixels. The pixel locations may be set either in an interleaving or a pseudo-random way. This reduces the template size and speeds up the subsequent score calculations. Other parameters may be stored for each enrolled “tile”, such as coverage (i.e., the percentage of “tile” pixels inside the fingerprint image) or quality/content (values returned by the image enhancement algorithm).

On identification, a candidate image undergoes the same processing. After its core location is found, all five “tiles” are extracted. A few rotated versions for each “tile” may be created. To obtain a matching score between the candidate and a template, a digital correlation between a candidate and a corresponding template “tile” is computed. This can be done via Fast Fourier Transform or in the image domain (which may be the preferred method). Not all five “tiles” need to be taken into account. For example, we could select three “tiles” out of five (from the candidate or template), such as the central “tile” plus two surrounding ones. In selecting tiles, we are trying to maximize the area of overlap between a candidate and template “tile” pair, as well as the coverage of the tile (i.e., if most of the tile lies outside the boundary of the image, such a tile will normally be omitted), and the quality and content of the template tile and the corresponding candidate tile.

In computing the correlation, a subarray is extracted from a candidate “tile” at pre-defined pixel locations which are the same as on enrollment. A few rotated, and a number of shifted, versions of the subarray are prepared before the search over templates begins. Usually we do not have to check all possible shifts since the “tiles” are supposed to be roughly aligned by the fingerprint core. If the “tiles” were binarized on enrollment, the same is done on identification. This is the fastest way to compute the correlation, since it includes only elementary binary operations, such as additions and subtractions, or an XOR operation. If the “tiles” were quantized rather than binarized on enrollment, then a standard correlation is computed (i.e. including products and additions). The pixels in the candidate and the template subarrays may be processed by chunks in pseudo-random order so that most shifts (where the pixel values do not add up to form a high correlation peak) will be discarded after the first few chunks. This significantly speeds up computation. The correlation value may be normalized, for example, by a total area of overlapping for “tiles”, or by standard deviations for both “tiles”. For each of the three “tile” pairs, the maximal value over all shifts and rotations is picked. Then the three correlation values are fused into a second screening metric of similarity. The fusion process may take into account the best angle for each of the three “tiles” (since for a matching template-candidate pair, the angles of each of the three “tiles” are expected to be close, while for a candidate of an imposter, the angles between the tile pairs tend to be more random).

The second screening metric of similarity is fused with Screen_score1 from the first screening step to obtain Screen_score2, as described in Section 1 and shown in FIG. 1.

7. Hardware Implementation

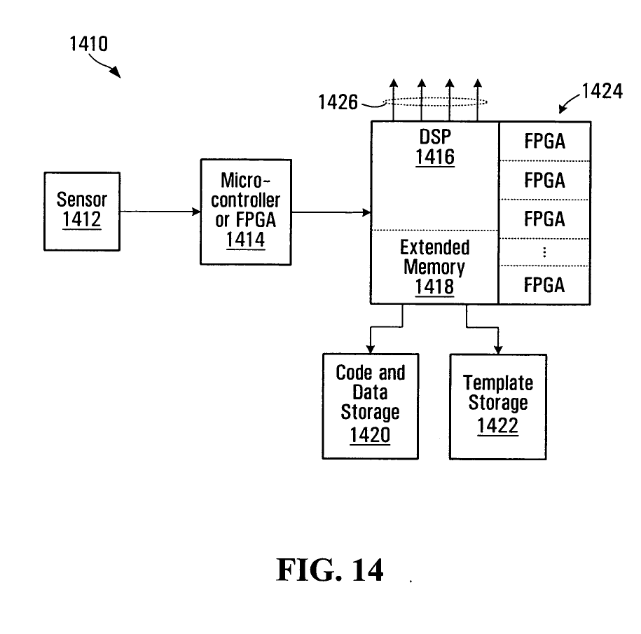

Referring to FIG. 14, an exemplary access control identification system 1410 for carrying out the described methods includes a fingerprint sensor 1412 which outputs to a controller 1414, such as a microcontroller or FPGA. Controller 1414 may output to a Digital Signal Processor (DSP) 1416 with extended memory 1418. The DSP 1416 may communicate with a code and data storage 1420, a template storage 1422, and a number of FPGA units 1424. There may be a number of communication ports 1426 associated with the DSP, depending on the system requirements.

The access control identification system 1410 of FIG. 14 is a standalone unit. In an alternate embodiment, the system can include a server, in which case some components may not be present, such as the template storage, the extended memory, and the FPGA units. A standalone unit has some important advantages over the server version, such as it can be easily integrated into an existing non-biometric access control system without networking. Also, it may provide better data and privacy protection, since the users' templates are not stored in a central database and, therefore, are not accessible to a hacker. However, the standalone unit must be able to complete the identification within a few seconds, which is a very challenging task given a large number of templates. Nevertheless, the approaches described in the previous sections can allow the standalone unit to achieve this. Further, for a standalone version, it is advantageous to perform as many steps as possible in parallel using low cost processors (the microcontroller and the FPGAs or, alternatively, low cost DSPs) to perform specialized tasks. The server version implies that the templates are stored in a central database, and the identification process occurs on the server. In this case there are no limitations to the processing power. However, if the system has many entry points, there might be problems with network congestion, with the synchronization of the entries, with queuing, etc.

The fingerprint sensor 1412 captures a fingerprint image both on enrollment and on identification. There are specific features which are advantageous for an access control fingerprint system. Specifically, the fingerprint sensor is advantageously not bulky so that it can fit into a wall mounted unit; at the same time, the sensor should be robust in various weather or climate conditions. In other words, it should provide good quality fingerprint images regardless of outside temperature, humidity, etc. On the other hand, for a system that handles ˜1:30,000 identification, the size of the active area of the sensor should be sufficiently large to capture most of the fingerprint area. Otherwise, it will not be possible to achieve desired accuracy. These requirements are quite tough, and, as a result, there are only a few fingerprint sensors available that could be used in the access control identification system.

The fingerprint capture process is controlled by micro controller 1414. It may optimize the sensor parameters on-the-fly to capture the best quality image possible. The captured image is received by DSP 1416 that in the standalone unit 1410 does most of the processing described in the previous sections. In this case the DSP advantageously has a high processing power and an extended memory so that it can process a large number of templates in real time. The system may also have an additional memory block 1422 (often called flash memory) to store all the templates enrolled. For example, if each template has a size of ˜1 kB, the 30,000 templates would require ˜30 MB of flash memory. The FPGA units 1424 may be programmed to perform some steps of the identification algorithm in parallel, thus speeding up the computations. For example, the FPGA units 1424 may calculate the dot product or the distance for the first screening, the classification score (Section 5), the fast minutiae score for the second screening, and the correlation for the “tile” algorithm.

For the server version, the DSP can be standard. It receives the image and sends it through one of the communication ports to the server. Alternatively, it can accomplish feature extraction, as shown in FIG. 1, and send the extracted information to the server, where further steps of enrollment and identification are performed. The DSP can also compress images (e.g., WSQ compression) and encrypt the information sent to the server. Upon receiving a positive identification signal from the server, the DSP can communicate with the other (non-biometric) components of the access control system.

It should be apparent to one skilled in the art that the invention may be embodied in other specific forms without departing from the spirit or essential characteristics thereof. For example, as mentioned in Section 1, some stages of the identification algorithm can be omitted, subject to system specific requirements. It will also be obvious that the transform used to generate translation invariant screening vectors, as described in subsection 2.1 need not be a Fourier transform. For example, instead Gabor filtering (which has been used in iris scanning systems) could be used. Where the transform is not a Fourier transform, the translation invariance for this transform may be achieved by, for example, using fiducial point(s) of the fingerprint image, or the eye pupil in the case of an iris scan.

While the methods and systems have been described in connection with access control, they may equally be applied to other one-to-many biometric applications, such as a system used by a law enforcement agency to obtain a background check on a suspect.

While exemplary embodiments of this invention have been described in conjunction with fingerprint images, it will be obvious that some teachings of this invention may be applied to other biometrics, such as a person's iris.

Other modifications will be apparent to those skilled in the art and, therefore, the invention is defined in the claims.

What is claimed is:

1. A method of biometric identification, comprising:
for each biometric template in a first universe of templates, determining a first metric of similarity between each first universe template and a candidate biometric;
based on determined first metrics of similarity, selectively accepting or rejecting said each first universe template as a possible match for said candidate biometric to thereby accept a second universe of templates, said second universe of templates being a sub-set of said first universe of templates;
for each second universe template, determining a second metric of similarity between said each second universe template and said candidate biometric;
determining a composite metric of similarity based on said first metric of similarity for said each second universe template and said second metric of similarity for said each second universe template.

2. The method of claim 1 further comprising:
based on determined composite metrics of similarity, selectively accepting or rejecting said each second universe template as a possible match for said candidate biometric to thereby accept a third universe of templates, said third universe of templates being a sub-set of said second universe of templates.

3. The method of claim 2 wherein said first metric of similarity is, at least in part, a measure of similarity between a translation invariant biometric feature vector representation of said each first universe template and a translation invariant biometric feature vector representation of said candidate biometric.

4. The method of claim 3 wherein said first metric of similarity is at least substantially orthogonal to said second metric of similarity.

5. The method of claim 3 wherein said translation invariant biometric feature vector representation of said each first universe template is a Fourier intensity representation and wherein said translation invariant biometric feature vector representation of said candidate biometric is a Fourier intensity representation.

6. The method of claim 3 wherein said translation invariant biometric feature vector representation of said each first universe template is a gradient magnitude representation linked to an alignment feature and wherein said translation invariant biometric feature vector representation of said candidate biometric is a gradient magnitude representation linked to an alignment feature.

7. The method of claim 3 wherein said translation invariant biometric feature vector representation of said each first universe template is a gradient direction representation linked to an alignment feature and wherein said translation invariant biometric feature vector representation of said candidate biometric is a gradient direction representation linked to an alignment feature.

8. The method of claim 5 wherein said first metric of similarity is also based on a metric of similarity between a gradient magnitude representation of said each first universe template linked to an alignment feature and a gradient magnitude representation of said candidate biometric linked to an alignment feature.

9. The method of claim 8 wherein said first metric of similarity is also based on a metric of similarity between a gradient direction representation of said each first universe template linked to an alignment feature and a gradient direction representation of said candidate biometric linked to an alignment feature.

10. The method of claim 9 wherein said gradient magnitude of said candidate biometric and said gradient direction of said candidate biometric are obtained at pre-selected points relative to said alignment feature.

11. The method of claim 10 wherein said candidate biometric is a fingerprint and each said alignment feature is a core or delta of said fingerprint.

12. The method of claim 1 wherein said second universe of templates has a pre-determined number of templates and wherein said selectively accepting or rejecting said each first universe template as a possible match for said candidate biometric to thereby accept said second universe of templates comprises accepting first universe templates until said pre-determined number of templates is reached.

13. The method of claim 3 wherein said translation invariant biometric feature vector representation of said each first universe template comprises a set of two-dimensional locations and wherein said translation invariant biometric feature vector of said candidate biometric comprises a value of a Fourier Transform intensity of said candidate biometric at each location of said set of two-dimensional locations.

14. The method of claim 13 wherein said first metric of similarity comprises a sum of each said value.

15. The method of claim 13 wherein said Fourier Transform intensity of said candidate biometric is a randomized Fourier Transform intensity.

16. The method of claim 5 further comprising obtaining said Fourier intensity representation of said candidate biometric as follows:
obtaining a two-dimensional representation of a Fourier Transform intensity from said candidate biometric;
for each area of a plurality of areas spanning pre-selected Fourier frequencies, obtaining a value representative of said area so as to obtain a set of values, said set of values comprising said Fourier intensity representation of said candidate biometric.

17. The method of claim 5 further comprising obtaining said Fourier intensity representation of said candidate biometric as follows:
obtaining a two-dimensional representation of a Fourier Transform intensity from a candidate biometric image;
obtaining a circular harmonic expansion of said Fourier Transform intensity;
obtaining a representation of magnitude of a pre-determined number of lowest order circular harmonics so as to obtain a set of values, said set of values comprising said Fourier intensity representation of said candidate biometric.

18. The method of claim 1 wherein said determining said composite metric of similarity comprises:
retrieving parameters defining straight line segments and deriving said composite metric of similarity from said first metric of similarity, said second metric of similarity, and said parameters.

19. The method of claim 18 wherein said straight line segments are derived as follows:
for each of a plurality of authorized biometrics, deriving a template;
for each of a plurality of candidate biometrics, each candidate biometric being either one of said authorized biometrics or an unauthorized biometric:
for each said template:
obtaining said first metric of similarity between said each candidate and said template;
obtaining said second metric of similarity between said each candidate and said template;
plotting said first metric of similarity and said second metric of similarity as a point on a Cartesian plot;
bisecting said plot with said straight line segments such that said plot is bisected into a region dominated by points representative of metrics of similarity between templates and candidate biometrics from which said templates were derived and a region dominated by points representative of metrics of similarity between templates and candidate biometrics which are other than candidate biometrics from which said templates were derived.

20. The method of claim 19 wherein each straight line segment is defined by ax+by +c=0 and said composite metric of similarity is determined from parameters for at least one of said straight line segments as ax+by +c where x is said first metric of similarity and y is said second metric of similarity.

21. The method of claim 1 further comprising:
for each template in one of said first universe of templates and said second universe of templates, obtaining a template characteristic vector;
for said candidate biometric, obtaining a candidate characteristic vector;
determining a distance between said candidate biometric and said each template based on said template characteristic vector and said candidate characteristic vector;
obtaining a list of selected templates such that each selected template has a lower distance from said candidate biometric than any template which is not a selected template;
for each of said selected templates, comparing said list of selected templates with a list of neighbour templates associated with each selected template to obtain a further metric of similarity between said candidate biometric and said each selected template.

22. The method of claim 21 wherein said further metric of similarity comprises a degree of overlap between said list of selected templates and said list of neighbour templates.

23. The method of claim 21 wherein said each template is in said first universe of templates and wherein each said first metric of similarity is, at least in part, a measure of similarity between said candidate characteristic vector and one said template characteristic vector.

24. The method of claim 23 wherein each said first metric of similarity is further derived from said further metric of similarity.

25. The method of claim 24 wherein said candidate characteristic vector is a translation invariant biometric feature vector representation of said candidate biometric and each said template characteristic vector is a translation invariant biometric feature vector representation of said each first universe template.

26. The method of claim 1 wherein said candidate biometric is a pixelated candidate image and wherein said determining a second metric of similarity between said each second universe template and said pixelated candidate image comprises:
determining a pre-defined fiducial point in said pixelated candidate image;
extracting a plurality of rectangular arrays of pixels from said pixelated candidate image, each rectangular array having a pre-defined location with respect to said fiducial point in said pixelated candidate image;
comparing values at pre-selected points of at least some of said rectangular arrays of pixels with values at corresponding pre-selected points stored in respect of rectangular arrays previously extracted from said each second universe template.

27. A biometric identification device, comprising:
a biometric sensor for obtaining a candidate biometric;
a memory storing a first universe of biometric templates;
a controller operable to:
for each biometric template in said first universe of biometric templates, determine a first metric of similarity between each first universe template and said candidate biometric;
based on determined first metrics of similarity, selectively accept or reject said each first universe template as a possible match for said candidate biometric to thereby accept a second universe of templates, said second universe of templates being a sub-set of said first universe of templates;
for each second universe template, determine a second metric of similarity between said each second universe template and said candidate biometric;
determine a third metric of similarity between said each second universe template and said candidate biometric, said third metric of similarity based on said first metric of similarity for said each second universe template and said second metric of similarity for said each second universe template.

28. A method to facilitate one-to-many biometric identification, comprising:
for each biometric of a plurality of biometrics, obtaining a template comprising a characteristic vector representing said each biometric;
determining a distance between each pair of templates based on each said characteristic vector;
based on distance determinations between each pair of templates, for said each template determining nearest neighbour templates;
augmenting said each template with a list of said nearest neighbour templates.

29. The method of claim 28 further comprising further augmenting said each template with said list of nearest neighbour templates associated with each of said nearest neighbour templates.

30. A method of one-to-many biometric identification, comprising:
for each template in a universe of templates obtaining a template characteristic vector;
for said candidate biometric, obtaining a candidate characteristic vector;
determining a distance between said candidate biometric and said each template based on said template characteristic vector and said candidate characteristic vector;
obtaining a list of selected templates such that each selected template has a lower distance from said candidate biometric than any template which is not a selected template;
for each of said selected templates, comparing said list of selected templates with a list of neighbour templates associated with each selected template to obtain a metric of similarity between said candidate biometric and said each selected template.

31. The method of claim 30 wherein said metric of similarity comprises a degree of overlap between said list of selected templates and said list of neighbour templates.

32. The method of claim 30 further comprising obtaining said list of neighbour templates associated with said each selected template by:
determining a distance between each pair of templates based on said template characteristic vector;
for each template, selecting said list of neighbour templates such that each neighbour template has a lower distance from said each template than any template which is not a neighbour template.

33. The method of claim 32 wherein said metric of similarity is a classification metric and further comprising determining a further metric of similarity between a candidate biometric and said each template based on said candidate characteristic vector and each said template characteristic vector and fusing said classification metric with said further metric to obtain a composite metric of similarity.
